(19) United States
(12) Patent Application Publication
(10) Pub. No.: US 2014/0242195 A1
(43) Pub. Date: Aug. 28, 2014

(54) AUTOMOTIVE SURFACE CONDITIONING SYSTEM

(71) Applicant: American Covers, Inc., Draper, UT (US)

(72) Inventor: Deborah E. Dixon, Draper, UT (US)

(73) Assignee: American Covers, Inc., Draper, UT (US)

(21) Appl. No.: 14/180,164

(22) Filed: Feb. 13, 2014

Related U.S. Application Data
(60) Provisional application No. 61/768,089, filed on Feb. 22, 2013.

(51) Int. Cl. A01N 59/00

(52) U.S. Cl. CPC A01N 59/00
USPC 424/719; 206/229; 206/524.1; 206/459.5

(57) ABSTRACT

An automotive surface treatment system can include an aqueous antimicrobial composition which is formulated for use with automotive surfaces and has a volatile organic content no greater than 0.5% by weight. The aqueous antimicrobial composition includes an antimicrobial agent which is a combination of quaternary ammonium salts, a combination of surfactants which is at least one polyoxyalkylene surfactant, a fragrance, water, and at least one of a glycol solvent, a conditioner, a shine enhancer, a moisturizer, and UV protectant. The system also includes a dispense container which is adapted to retain the antimicrobial composition within the container and instructions attached to the dispenser. The instructions include directions to apply the antimicrobial composition to an automotive surface.

### RELATED APPLICATION(S)

This application claims priority to U.S. Provisional Application No. 61/768,089, filed Feb. 22, 2013 which is incorporated herein by reference.

### BACKGROUND

Interior automotive care products offer a wide variety of options from cleaning to protection. Spray cleaners and protectants can offer somewhat effective results but also tend to be difficult to store within an automobile such that use generally requires inconvenient storage options. Automotive surfaces can also vary widely in material and texture. For example, most automobile interiors include substantial molded plastic which can vary from textured molded panels, glossy molded parts, and clear display windows. Other surfaces can include upholstery, leather, glass, metal, and fabric. Such a variety of material surfaces can present challenges in terms of avoiding damage while still providing effective cleaning. Furthermore, automotive care products tend to focus on a single problem such as cleaning, protectant, or improving shine. Although currently available products provide some benefits, there is still a need for improved options for care of automotive interiors. To date, no commercially available auto interior products contain antimicrobial compounds, other than those added as preservatives, thus offering the ability to sanitize surfaces as well as to remove soil and protect surfaces.

### SUMMARY

It has been recognized that automotive surfaces raise unique issues with respect to cleaning and conditioning. As such, an automotive surface treatment system can include an aqueous antimicrobial composition which is formulated for use with automotive surfaces and has a volatile organic content no greater than 0.5% by weight. The aqueous antimicrobial composition includes an antimicrobial agent which is a quaternary ammonium salt, a surfactant which is at least one polyoxyalkylene surfactant, a fragrance, water, and at least one of a glycol solvent, a conditioner, a shine enhancer, a moisturizer, and UV protectant. The system also includes a dispense container which is adapted to retain the antimicrobial composition within the container and instructions attached to the dispenser. The instructions include directions to apply the antimicrobial composition to an automotive surface. The dispense container can be any suitable container such as a spray bottle, canister, pouch or the like. Containers which are readily stored in automotive compartments are particularly desirable.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a perspective view of a spray bottle for use with the aqueous antimicrobial compositions in connection with one example of the treatment system.

FIG. 2 is a perspective view of a reclosable container for use with the aqueous antimicrobial compositions in connection with one example of the treatment system.

FIG. 3 is a side cross-section view of a single layer construction antimicrobial conditioning wipe in accordance with one example of the invention.

FIG. 4 is a side cross-section view of a multi-layer construction antimicrobial conditioning wipe having two layers in accordance with another example of the present invention.

FIG. 5 is a side cross-section view of a multi-layer construction antimicrobial conditioning wipe including formulation containing layers and contact layers in accordance with yet another example of the present invention.

FIG. 6 is a side cross-section view of a composite single layer construction having alternating cleaning zones and conditioning zones oriented on an exposed cleaning surface in accordance with still another example of the present invention.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

Definitions

In describing and claiming the present invention, the following terminology will be used.

The singular forms “a,” “an,” and “the” include plural referents unless the context clearly dictates otherwise (the antimicrobial works as a combination, that's why I made a change to the language). Thus, for example, reference to “an antimicrobial agent” includes reference to one or more of such materials and reference to “applying” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity can depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Automotive Surface Treatment Systems

Cleaning and preserving of automotive surfaces presents unique challenges in terms of material variety, texture and appearance. Automotive surfaces can include textured molded plastics, as well as smooth glossy plastic surfaces. As such, certain cleaning and treatment compositions may perform well on textured plastics, while leaving streaks on polished plastics. Typical cleaning and treatment compositions often cannot be effectively and safely used on automotive surfaces. Industrial and household cleaners contain harsh chemicals, such as bleach, that, with repeated use, can damage the interior surfaces. In addition, automotive surfaces can have exceptionally high amounts of microbial populations due largely to the frequency of usage and lack of routine cleaning. There are resident microbes and transient microbes, which come from the environment or from human or animal vehicle passengers. The majority of microbes are not pathogenic, but studies have found pathogens like methicillin resistant Staphylococcus aureus (MRSA) present in up to 2% isolates from auto surfaces, the highest percentage found on steering wheels. As such, an automotive surface treatment system can include an aqueous antimicrobial composition which is specifically formulated for use with automotive surfaces that acts as a antibacterial sanitizer along with providing conditioning and UV protection.

The automotive surface treatment system can include one or more compositions which are formulated for use in association with particular automotive surfaces. However, among these compositions, there are common attributes which make them suitable for automotive surfaces. Specifically, the aqueous antimicrobial composition includes an antimicrobial agent which is a combination of quaternary ammonium salts, a combination of surfactants which includes at least one polyoxyalkylene surfactant, a fragrance, water, and at least one of a glycol solvent, a conditioner, a shine enhancer, a moisturizer and a UV protectant. Volatility (i.e. vaporization) of all components but the fragrance can be minimized. This can help to improve the perceived scent and to avoid vaporization of other components which may cause undesirable affects as a vapor. Consequently, volatile organic content can be exceptionally low, and is most often less than 0.5% by weight. Furthermore, components can generally be chosen as biodegradable, non-toxic, and/or ecologically friendly.

The antimicrobial agent can act to destroy microbes, bacteria, fungus and other microorganisms. Effectiveness can depend on specific materials, contact time, and other variables. However, as a general guideline, over 99% and in some cases there is over 99.9% reduction of bacteria in a given contact time. Such results can generally be achieved in less than one minute and in some cases less than 30 seconds of contact time, depending on the automotive surface and specific formulation. However, contact time usually is no longer than 5 minutes in most antimicrobial products to make them effective while being user friendly without a long wait for drying time. As part of the automotive surface treatment system, the antimicrobial agent can be a combination of quaternary ammonium salts. Although a variety of quaternary ammonium salts can be used, those having an alkyl group are of particular interest. Non-limiting examples of quaternary ammonium salts include n-alkyl dimethyl benzyl ammonium chloride, n-alkyl dimethyl ethylbenzyl ammonium chloride, benzalkonium chloride, methylacryloxylethyl benzyl dimethyl ammonium chloride, methacryloxylethyl m-chlorobenzyl dimethyl ammonium chloride, methacryloxylethyl cetyl ammonium chloride, dequalinium chloride, benzethonium chloride, methylbenzethonium chloride, cetalkonium chloride, cetylpyridinium chloride, cetyltrimethyl ammonium bromide, cetrimonium, cetrimide, dofanium chloride, tetraethyl ammonium bromide, didecyldimethyl ammonium chloride, domiphen bromide, and combinations thereof. In one embodiment, the antimicrobial agent can be at least two quaternary ammonium salts. In one specific aspect, the antimicrobial agent can be a combination of alkyl quaternary ammonium salts including n-alkyl dimethyl benzyl ammonium chloride and n-alkyl dimethyl ethylbenzyl ammonium chloride. Such antimicrobial agents can also aid as a secondary emulsifier, can provide stability and are not detrimentally affected by changes in pH.

Although exact proportions can vary depending on the formulation, the quaternary ammonium salts can constitute less than about 1% by volume, and often from about 0.005% to 0.5% by volume. Most often the quaternary ammonium salt can be present from about 0.007% to about 0.4% by volume. As a general guideline, the antimicrobial compositions can have greater than 40% by volume water.

Although some formulations of the antimicrobial composition have antimicrobials which are limited to only quaternary ammonium salts, some formulations may include other chemicals and compounds with varying degrees of antimicrobial properties. Many of such compounds work on the same principle as the quaternary ammonium salts. Bacteria and other microbes possess a net negative charge, while quaternary ammonium salts and other compounds are positively charged or known as cationic compounds. There is attraction between the compound and the cell membrane, causing damage and subsequent death to the cell. The antimicrobial conditioning wipe can also include an antimicrobial agent which can disinfect and/or sanitize a surface upon contact for a predetermined amount of time. Some antimicrobial agents will provide a strong initial kill rate or removal of undesirable organisms while others can provide long-term persistent effects. Suitable secondary antimicrobial agents can include, but are not limited to, e-polylysine, ethylenediaminetetraacetic acid (EDTA), metal cations, essential oils, triclosan, triclocarban, chlorhexidine gluconate, chloroxylenol (PCMX), alcohols, cationic dye, and combinations thereof. Suitable metal cations can include silver cations, copper cations, gold cations, etc. Such metal cations can tend to provide sustained and prolonged antimicrobial activity when left upon a surface. Suitable essential oils with antimicrobial action can include, but are not limited to, lavender oil, mint oil, thymol, citrus, etc. Secondary antimicrobial agents can also be present in very limited amounts, if used at all. For example, secondary antimicrobial agents usually comprise less than about 0.5% by volume, and often from about 0.001% to 0.2% by volume, although higher proportions may be used. Exact amounts can depend largely on the specific antimicrobial agent chosen since each agent can have differing effective dosages and varying shelf life.

Solvents and surfactants can aid in maintaining dispersion, as well as facilitate removal of debris such as dirt and grime from an automotive surface. Surfactants are also included in the antimicrobial composition and can provide wetting, penetration, and can aid as a dispersant. Suitable surfactants can also be water soluble and avoid streaking and film residue when used on smooth surfaces. For example, at least one polyoxyalkylene surfactant can be used. Non-limiting examples of suitable types/classes of surfactants can include anionic surfactants, cationic surfactants, nonionic surfactants, amphoteric surfactants and hydrotropes, combinations thereof, and the like. Commercially available surfactants include TERGITOL series and TRITON series, phosphate ester ether such as TRITON 1455, among others. In one specific example, the surfactant can include a polyoxyethylene trimethylnonyl ether surfactant and a secondary alcohol ethoxylate which is commercially available as TERGITOL TMN-6, TERGITOL 15-S-9, TERGITOL 15-S-5, and TERGITOL 15-S-7, respectively. Other non-limiting surfactants can include alkyl polyethyleneoxy ethanol surfactant, TRITON CF-21, TERGITOL L-64, oxirane, methyl-, polymer with oxirane, mono(bis(1-methylpropyl)phenyl)ether; polyether polyol, and the like.

Although a single surfactant can be used, it is often desirable to include a mixture of surfactants in order to balance wetting, foaming and other variables. However, as a general guideline, the total surfactant concentration can range from about 0.1% to about 10% by volume. Specific amounts can vary depending on the formulation and other components. For example, the formulations described herein can vary from cleaners and detailing compositions, leather cleaners and conditioners, to shine enhancing protectant formulations. Cleaners and detailing compositions can typically be on the lower end of surfactant ranges and often range from about 0.1% to about 5% by volume. In contrast, leather cleaners and conditioners can have substantially higher surfactant concentrations ranging from about 1% to about 10% by volume. Shine enhancing protectant formulations can incorporate intermediate concentrations of surfactant. For example, in some embodiments, shine enhancing formulations can have from about 1% to about 6% by volume surfactant. These ranges are merely guidelines and can vary based on specific components and performance criteria.

Fragrance used in the antimicrobial compositions can be chosen to enhance olfactory appeal. Non-limiting example of suitable fragrance can include terpenes such as limonene, camphor, terpineol, geraniol, citronellal, linalool, nerolidol, and the like, fragrant esters such as geranyl acetate, ethyl butyrate, octyl acetate, and the like, and others. Non-limiting examples of commercial fragrances include Tropical and Clean.

The aqueous antimicrobial composition can be formulated as a cleaning composition. As such, a solvent system can be included in order to improve cleaning performance. In some formulations, a cleaning composition can have greater than 85% water and include a glycol solvent. Glycol solvents are particularly suitable and can be used in combinations of multiple glycol compounds, although paraffin solvents can also be used (e.g. ISOPAR V). Non-limiting examples of glycol solvents that meet VOC requirements include dipropylene glycol monoethyl ether, diethylene glycol monoethyl ether, dipropylene glycol methyl ether, diethylene glycol monobutyl either, butyl cellusolve acetate, ethylene glycol butyl ether actetate, glycol ether, ethylene glycol monobutyl ether, propylene glycol n-propyl ether, and combinations thereof. Such glycol solvents are commercially available as DOWANOL series, CARBITOL series of solvents, and CELLUSOLVE among others. While many of these glycol solvents offer desired evaporation rates, meet VOC requirements, they contain a strong odor and therefore, their use in formulations with certain fragrances, such as tropical and clean disclosed herein, can present challenges. Concentrations of glycol solvents can typically range from about 0.1% to 10%, and in some cases from 0.5% to about 5% by volume. These are low VOC or VOC exempt solvents. They are also moderately evaporative solvents which enable suitable time for surface cleaning. They also work in combination with surfactants to heighten surfactant performance, oftentimes enabling lower concentrations of surfactants to be incorporated in the cleaning formulation.

When the cleaning composition is formulated as a detailing cleaner, a conditioner can be added to the composition. Such detailing cleaners can have greater than 89% water, and in some cases greater than 93% water. Conditioning agents can provide long-term residual effects on the surface such as increasing suppleness, sheen, and the like. Non-limiting examples of conditioners can include glycerin, Vitamin E, 2-cyano-3,3-diphenylacrylic acid 2-ethylhexyl ester (octocrylene), aloe (A.barbadensis), Vitamin E derivatives, lanolin, lanolin derivatives, sodium diamphoacetate, sodium lauroamphoacetate, cocoamidopropyl betaine, sodium cocoamphoacetate, cocophosphatidyl PG dimonium chloride, and combinations thereof. Vitamin E can be particularly effective as a conditioner and UV protectant, and can most often be present in the composition at least 200 ppm.

The antimicrobial composition can also be formulated as a mid-shine multi surface protectant. The mid-shine protectant can be highly effective for cleaning non porous hard surfaces, but has chemicals mild enough and compatible to also perform as a leather cleaning composition. Leather cleaning compositions can include a conditioner, a shine enhancer, a moisturizer, and UV protectant. Such formulations also can have 65% to 85% water. The conditioner can be used as with the detailing cleaners. Conditioners can be present in the cleaning compositions from about 0. 1% to about 3% by volume, although up to about 10% by volume can be useful. Shine enhancers can also be helpful in providing increased luster and shine in appearance of the surface due to remaining residue. Some silicone shine enhancers can also act as humectants. Non-limiting examples of shine enhancers can include polysiloxanes, and the like. Specific examples of polysiloxanes can include, but are not limited to, polydimethylsiloxane (e.g. 500, 1000, 5000 and 30,000 cst), PEG-12 dimethicone, octamethylcyclotetrasiloxane (D4 silicone), and the like. In some cases, the shine enhancer can be provided as a silicone emulsion (e.g. ethoxylated solvents such as E 60-1000 silicone emulsion available from Wacker and MEM—0349 Emulsion from Xiameter/Dow Corning). Proportions of high molecular weight siloxanes can be varied in mixture with lower weight siloxanes. Specifically, proportions of high molecular weight siloxanes can be increased in order to produce an increase in shine (i.e. natural shine, mid-shine, versus high shine). Shine and other conditioning properties can be controlled by the concentration (percent) of an emulsion base, such as E 60 1000 added to the formulation. Moisturizers can be included to provide residual effects such as improved feel, as well as restoration of appearance. Non-limiting examples of moisturizer can include aloe, glycerin, shea butter, and the like. Protectant compositions can include the conditioner, the shine enhancer, the moisturizer, and UV protectant.

Window and glass cleaners can be formulated using these principles with a pH of about 10. For example, quaternary ammonium salts, ethoxylate surfactant, an ethylene glycol, alkyl polyglucosides (e.g. TRITON CG-600), isopropyl alcohol, and water can be mixed to form a suitable glass cleaner. Fragrance can optionally be included but can contribute to streaking.

The antimicrobial cleaning composition can generally be prepared by thoroughly mixing components. For example, fragrance, antimicrobial, and surfactants can be mixed with water to produce an actives precursor formulation. Gentle mixing at about 500 rpm or less can be performed for about 3-10 minutes. Solvents can be added along with any remaining components. For detailing cleaner compositions, conditioning agents and solvents can be mixed separately from the actives precursor formulation to form a conditioning premix. Glycerin can be mixed into the actives precursor formulation until fully dissolved. The conditioning premix can then be added to the actives precursor formulation. Mixing can be continued for about 8-15 minutes to form the detailing cleaner. Leather cleaning and protectant compositions can also include an emulsion formation stage. For example, shine enhancers can be mixed with conditioning agents in order to form an oil phase. Fragrance, antimicrobial, surfactants and other optional components can be mixed in water to form an aqueous phase. When glycerin, DOSSS or other moderately soluble conditioners or components are used, these can be independently mixed and then gradually added to the aqueous phase during mixing until fully dissolved. The DOSSS is soluble in glycerin, so it can be dissolved in glycerin before adding to the other ingredients. This premixing step eliminates issues that use of liquid, prediluted DOSSS introduces into the formulation. The diluent solvents for DOSSS have strong odors, thus affecting scent character of compositions containing Clean or Tropical fragrances. The oil phase can then be added slowly (i.e. stepwise aliquots or continually) to the aqueous phase while mixing. For example, glycerin and aloe leaf extract are water soluble, while octocrylene and vitamin E acetate are oil soluble. Although specific conditions can vary, vigorous mixing at about 3000 rpm for about 30 minutes can be suitable to allow formation of a suitable emulsified composition. For antimicrobial compositions formulated as high shine, the oil phase can be introduced into the aqueous phase in multiple graduated volumes. Each successive introduction of oil phase can be performed at successively higher mixing speeds (e.g. 1000 rpm, 2000 rpm, 3000-4000 rpm, etc). Upon completion of mixing, the composition can be allowed to settle as foaming dissipates and settles.

Most surfaces can be sensitive to repeated and/or extended contact with highly acidic or basic formulations. As such, the aqueous antimicrobial composition can be delivered at a neutral pH from about 6 to about 8.5 upon use. In some cases, the pH can be from about 5.5 to about 6. Thus, the pH within the wipe or liquid formulation may be distinct from the pH upon contact with a surface. This can be a function of reactions, release profiles or other factors which change the pH upon use.

Other additives can optionally be included in the antimicrobial compositions. Non-limiting examples can include polysaccharides, pH buffers, emulsifiers (e.g. sorbitans such as SPAN and TWEEN), microcapsules (e.g. release of fragrance, shine enhancers, or other long term actives), foaming agents, dye, thickening agent, gelling agent, emollients, and the like. Formulations can be impregnated into the substrate as a gel composition. Suitable gels can be formed using gelling agents such as, but not limited to, animal product, carrageenan, polysaccharide source would be something like Triton CG-600 as it is a polyglycoside.

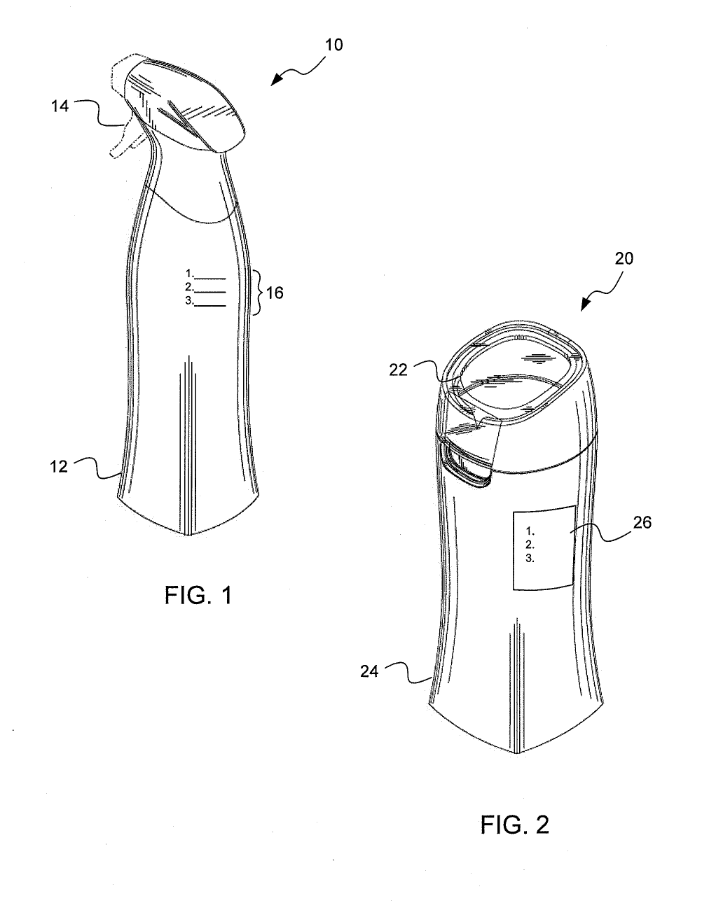

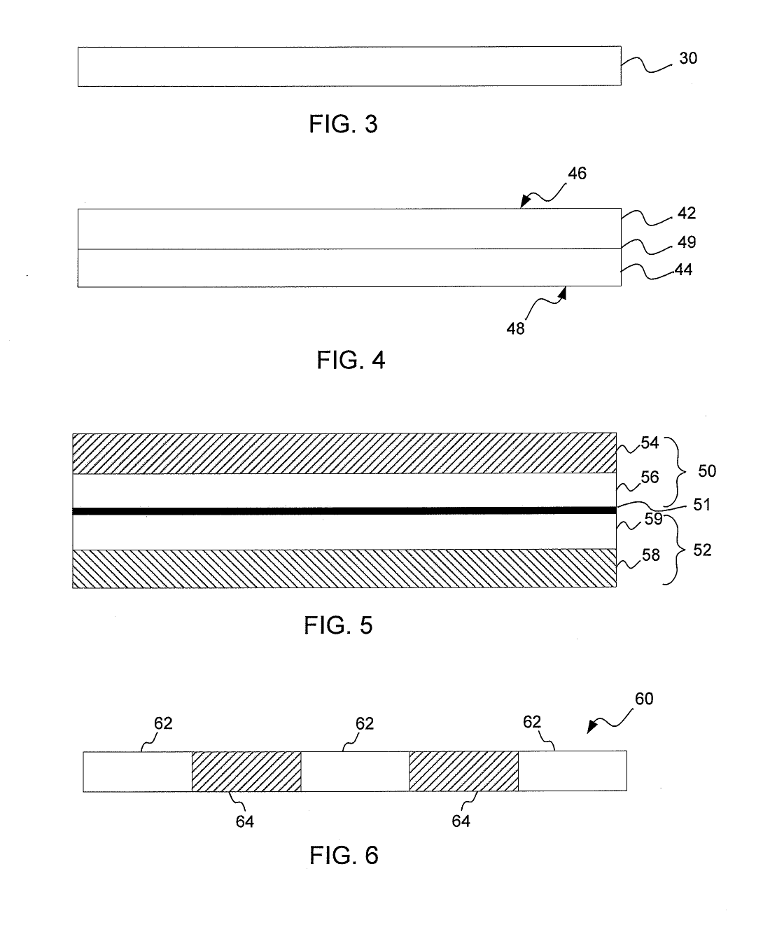

The system also includes a dispense container which is adapted to retain the antimicrobial composition within the container and instructions attached to the dispenser. The dispense container can be any suitable container such as a spray bottle, canister, pouch or the like. Containers which are readily stored in automotive compartments are particularly desirable. FIG. 1 illustrates a dispense container configured as a spray bottle 10. The antimicrobial composition can be formulated as a spray. The spray bottle can optionally have a lower base end 12 which is sized to fit within a standard automotive cup holder or within an automotive door pocket. Although sizes can vary, typically a base diameter from about 3 inches to about 5.5 inches can be suitable. The spray bottle can also include a spray mechanism 14. The spray mechanism can utilize a trigger spray as illustrated, or can be any other suitable mechanism such as, but not limited to, a push button dispenser, and the like.

Alternatively, the dispense container can be a reclosable container 20 as illustrated in FIG. 2. In this case, the antimicrobial composition is disposed on a plurality of wipes which are located within the reclosable container. The reclosable container has an access opening 22 from which the plurality of wipes can be removed. The reclosable container can further include a lower base 24 which is adapted to fit within a standard automotive cup holder, within an automotive door pocket, glove box or ash tray. Although sizes can vary, typically a lower base diameter from about 3 inches to about 5.5 inches can be suitable. The reclosable container can be formed of rigid plastic such as polyethylene, polypropylene, or the like. Alternatively, the reclosable container can be formed as a flexible pocket or envelope. For example, single use packages can be used which include a simple film envelope.

Non-porous hard surfaces such as dashboard, door trim, window switches, radio knobs, control buttons and other plastic molded coverings, metal, vinyl can be susceptible to damage or drying with harsh chemicals typically used for cleaning homes or other environments. Leather, fabric, and other porous car seat materials can also be particularly sensitive to harsh chemical treatments. The above formulations provide options which are more amenable to such surfaces while providing effective cleaning, conditioning and protecting results.

Regardless of the particular dispense container configuration, the instructions can be applied to the outer surface of the container. The instructions include directions to apply the antimicrobial composition to an automotive surface. For example, cleaning compositions can be directed for use as a first step in cleaning soiled automotive surfaces. Such compositions can be particularly suited to removing moderate to heavily soiled automotive surfaces such as plastic trim, dashboards, control buttons, door trim, window switches, and the like. Detailing cleaners can be used as a cleaning composition where minimal to light soiling exists. In contrast, leather cleaning and conditioning formulations can include instructions regarding applying the composition directly to leather surfaces. Typically, initial application of the formulations can be followed by removal of excess liquid. However, in some cases, it can be desirable to allow a period of time to lapse before removing excess. This can allow conditioners and other components to penetrate into porous surfaces for longer lasting effects. Compositions herein are typically formulated to minimize such time to about 20 seconds up to about 2 minutes. Further, instructions can recommend specific application cloths.

The instructions 16 can be printed directly on the dispense container as illustrated in FIG. 1. Alternatively, the instructions can be printed on a label 26 which is adhered to the dispense container as illustrated in FIG. 2.

When the antimicrobial compositions are embedded on a plurality of wipes, an absorbent laminar substrate can be used having an exposed cleaning surface. Various chemical formulations can be included within the substrate as discussed herein. These formulations can be included as a composite multi-functional mixture or in dedicated regions of the antimicrobial conditioning wipe.

For example, FIG. 1 illustrates an antimicrobial conditioning wipe 30 which is a single layer construction. In this case, the wipe has the composite multi-functional mixture absorbed in the laminar substrate. In this case, the composite multi-functional mixture includes the antimicrobial composition as a substantially homogeneous formulation embedded throughout the antimicrobial conditioning wipe 30.

Alternatively, the wipe can be a multi-layer laminate construction such as those shown in FIG. 4 and FIG. 5. Multi-layer laminate construction allows for segregation of formulation components and respective function. For example, cleaning and conditioning agents can be segregated in separate layers. Optionally, segregated layers or regions can be visually identified by including a dye or differing dyes in each portion. FIG. 4 shows a bi-layer construction including a cleaning layer 42 and a conditioning layer 44. The cleaning layer includes a cleaning agent and the conditioning layer includes the conditioning agent. In this case, the cleaning layer can have an exposed cleaning surface 46 which is used first. During use, the cleaning surface 46 can be effective at removing debris and optionally providing additional disinfecting and/or antimicrobial action. Correspondingly, the conditioning layer 44 can have an exposed conditioning surface 48 which is used subsequent to the cleaning surface 46. During use, the conditioning surface 48 deposits conditioning agent and other optional components to surfaces. An optional bonding layer 49 can be oriented between the cleaning layer 42 and the conditioning layer 44. The bonding layer can be configured to secure the cleaning layer 42 to the conditioning layer 44 and at least partially prevent migration of materials across layers. The bonding layer can be a film, adhesive or other polymer barrier which bonds with each of the cleaning and conditioning layers.

FIG. 5 illustrates a multi-layer laminate construction having a composite cleaning portion 50 and a composite conditioning portion 52. The composite cleaning portion 50 can include a cleaning contact layer 54 and a cleaning formulation layer 56. The cleaning contact layer can be a suitable substrate fabric or material which provides contact to a surface for cleaning. Optionally, the cleaning contact layer 54 can be a non-woven substrate having abrasive surface. Further, the cleaning contact layer 54 can have apertures or pores which allow distribution of the cleaning formulation therethrough. Upon use, cleaning formulation embedded in the cleaning formulation layer 56 can be released and migrate through the cleaning contact layer 54 for distribution across the surface. Similarly, the composite conditioning portion 52 can include a conditioning contact layer 58 and a conditioning formulation layer 59. An optional bonding layer 51 can be used to secure the composite cleaning portion 50 to the composite conditioning portion 52.

In yet another example, the antimicrobial conditioning wipe can be a composite single layer construction having at least one cleaning zone and at least one conditioning zone oriented on an exposed cleaning surface. FIG. 6 illustrates one such configuration with a composite single layer wipe 60 having cleaning zones 62 and conditioning zones 64. In this case, the composite single layer construction can include parallel alternating cleaning zones and conditioning zones, i.e. adjacent stripes. However, other segregated zones can be used such as, but not limited to, checkered, islands (spots), irregular patterns, or other designs.

Regardless of the specific configuration of the wipe, the absorbent laminar substrate can be formed of a suitable material which is capable of retaining the corresponding components. In one specific example, the absorbent laminar substrate is a non-woven material. Non-limiting examples of such non-woven materials can include perforated, punctured, melt blown, low-lint polyester-polyamide fabric, viscose-polyester spunlace fabric, and the like. One commercial example of a melt blown polypropylene wipe substrate material with an embossed pattern is available from Jiangyin Golden Textile Co. Low lint non-woven wipe material is a fabric polyester-polyamide blend is available from Xianmen Jierui Anti-Electrostatic Equipment Co. Spunlace fabric material of viscose and polyester is commercially available from Beijing Soonercleaning Technology Co. Although thicknesses can vary, typical thicknesses range from about 0.08 mm to about 2 mm, and most often from about 0.3 mm to about 0.8 mm. The exposed cleaning surface can be soft and non-scratching; although in some cases a modestly abrasive texture can be desirable to increase removal of adhered debris from a surface, as long as the surface is not damaged.

### EXAMPLES

### Example 1

A multipurpose antimicrobial cleaning composition was prepared having the composition set forth in Table 1. Proportions are provided as maximum nominal amounts for purposes of processing variations and desired performance characteristics. This cleaner is formulated to have a matte finish.

TABLE 1

| | | Vapor Pressure | |
|---|---|---|---|
| Component | % by volume | (mmHg) | VOC |
| Clean or Tropical Fragrance | 1 (maximum) | <2 | Yes- |
| | | | negligible |
| | | | contribution |
| dipropylene glycol monoethyl ether | 0.3 Max | 0.28 | Yes |
| (DOWANOL DPM) | | | |
| diethylene glycol monoethyl ether | 1-3 | 0.07 | No |
| (CARBITOL) | | | |
| quaternary ammonium salt (BTC 2125) | 0.3 (0.15 | NA | Negligible- |
| 80% active | from each of | | Ethanol |
| | two salts) | | |
| polyoxyethylene trimethylnonyl ether | 0.1-0.5 | 15 | No |
| (TERGITOL TMN-6) 90% active | | | |
| secondary alcohol ethoxylate | 0.1-0.5 | <0.01 | No |
| (TERGITOL 15-S-5) | | | |
| Deionized water | Balance | NA | No |

BTC 2125 includes alkyl (68% C12, 32% C14), dimethyl ethylbenzyl ammonium chloride, quaternary ammonium compounds, benzyl-C12-18-alkyldimethyl, chlorides, ethanol, and water.

The composition resulted in a colorless liquid having a viscosity of 1.183 cSt (22° C.) and 0.755 cSt (44.5° C.) as measured using ASTM D445 and D446 with Ubbelohde viscometers, size 1. The composition was non-flammable (ASTM D56) and had a measured pH of 5.39 (at 25° C. using ASTM E70) and relative density of 1.00088 (at 21° C. using ASTM D891, method B). Surface energy contact angle was also measured using ASTM D5946 on a PC/ABS coupon. Average surface energy was 59 dynes/cm. UV resistance was measured using SAE J2412 (May 2004) with exposure to a Xenon Arc at 1241 kJ/m2 (equiv. 793 hours) on PC/ABS, EPDM, PP coupons and leather coupons. Results indicated no change on PC/ABS, EPDM, and PP samples, while leather exhibited only slightly brighter color.

### Example 2

A detailing antimicrobial cleaning composition was prepared having the composition set forth in Table 2. Proportions are provided as maximum nominal amounts for purposes of processing variations and desired performance characteristics. Detailer is formulated to produce a matte finish, without shine.

TABLE 2

| | | Vapor Pressure | |
|---|---|---|---|
| Component | % by volume | (mmHg) | VOC |
| Tropical fragrance and Clean | 1 (maximum) | <2 | Yes- |
| Fragrance | | | negligible |
| | | | contribution |
| DOWANOL DPM | 0.3 max | 0.28 | Yes |
| CARBITOL (low gravity) | 1-3 | 0.07 | No |
| BTC 2125 | 0.3 (0.15 | NA | Negligible- |
| 80% active | from each of | | Ethanol |
| | two salts) | | |
| TERGITOL TMN-6 | 0.25-0.75 | 15 | No |
| 90% active | | | |
| TERGITOL 15-S-5 | 0.25-0.75 | <0.01 | No |
| Glycerin | 2-4 | 0.003 | No |
| 2-cyano-3,3-diphenylacrylic Acid 2- | 0.1-0.5 | NA | No |
| Ethylhexyl Ester (Octocrylene) | | | |
| Deionized water | Balance | NA | No |

### Example 3

A leather cleaner and mid shine conditioner antimicrobial cleaning composition was prepared having the composition set forth in Table 3. Proportions are provided as maximum nominal amounts for purposes of processing variations.

TABLE 3

| | | Vapor Pressure | |
|---|---|---|---|
| Component | % by volume | (mmHg) | VOC |
| Tropical fragrance and Clean Fragrance | 1 (maximum) | <2 | Yes |
| BTC 2125 | 0.3 (0.15 | NA | Negligible- |
| 80% active | each of two | | Ethanol |
| | salts) | | |
| TERGITOL TMN-6 | 0.5-1.5 | 15 | No |
| 90% active | | | |
| TERGITOL 15-S-5 | 0.5-1.5 | <0.01 | No |
| Glycerin | 2-4 | 0.003 | No |
| 2-cyano-3,3-diphenylacrylic Acid 2- | 0.1-0.5 | NA | No |
| Ethylhexyl Ester (Octocrylene) | | | |
| polydimethylsiloxane emulsion (E 60- | 8-12 | NA | exempt |
| 1000) | | | |
| Aloe barbadensis leaf extract juice | 0.5-1 | NA | No |
| Deionized water | Balance | NA | No |

### Example 4

A high-shine protectant antimicrobial cleaning composition was prepared having the composition set forth in Table 4. Proportions are provided as maximum nominal amounts for purposes of processing variations.

TABLE 4

| | | Vapor Pressure | |
|---|---|---|---|
| Component | % by volume | (mmHg) | VOC |
| Clean and Tropical Fragrances | 1 (maximum) | <2 | Yes- |
| | | | negligible |
| | | | contribution |
| BTC 2125 | 0.15 each of | NA | Negligible- |
| 80% active | two salts | | Ethanol |
| polydimethylsiloxane emulsion (E 60- | 23-27 | No | No |
| 1000) | | | |
| TERGITOL TMN-6 | 0.5-2 | 15 | No |
| 90% active | | | |
| TERGITOL 15-S-5 | 0.5-2 | <0.01 | No |
| Glycerin | 2-4 | 0.003 | No |
| 2-cyano-3,3-diphenylacrylic Acid 2- | 0.1-0.5 | NA | No |
| Ethylhexyl Ester (Octocrylene) | | | |
| Aloe barbadensis leaf juice extract | 0.5-1 | NA | No |
| Deionized water | Balance | NA | No |

The composition resulted in a white liquid having a viscosity of 2.98 cSt (22° C.) and 2.04 cSt (44.5° C.) as measured using ASTM D445 and D446 with Ubbelohde viscometers, size 1. The composition was non-flammable (ASTM D56) and had a measured pH of 5.25 (at 25° C. using ASTM E70) and relative density of 1.00615 (at 21° C. using ASTM D891, method B). Surface energy contact angle was also measured using ASTM D5946 on a PC/ABS coupon. Average surface energy was 60 dynes/cm. UV resistance was measured using SAE J2412 (May 2004) with exposure to a Xenon Arc at 1241 kJ/m2 (equiv. 793 hours) on PC/ABS, EPDM, PP coupons and leather coupons. Results indicated no change on PC/ABS, EPDM, and PP samples, while leather exhibited only slightly brighter color.

### Example 5

A carpet and upholstery cleaner can also be formulated using the principles set forth herein. One specific carpet and upholstery cleaner was prepared having the composition set forth in Table 5. Proportions are provided as maximum nominal amounts for purposes of processing variations and desired performance characteristics.

TABLE 5

| Component | % by volume | VOC |
|---|---|---|
| Fragrance | 1 (max) | negligible |
| diethylene glycol monobutyl ether, diethylene | 2-4 | LVP |
| glycol monoethyl ether | | |
| (BUTYL CARBITOL) | | |
| quaternary ammonium salt (BTC 2125) 80% | make up | negligible |
| active | to 0.62-0.64 | |
| | NCL | |
| ethylene glycol monobutyl ether (BUTYL | 0.3 (max) | Yes |
| CELLOSOLVE) | | |
| secondary alcohol ethoxylate (TERGITOL | 1-2 | No |
| 15-S-5 or S-9) | | |
| TRITON CF-21 or TERGITOL L-64 | 1-2 | No |
| Deionized water | Balance | No |

### Example 6

A silicone-free protectant was also formulated having the composition set forth in Table 6. Proportions are provided as maximum nominal amounts for purposes of processing variations and desired performance characteristics.

TABLE 6

| Component | % by volume | VOC |
|---|---|---|
| Fragrance | 1 (max) | negligible |
| Aloe barbadensis | 0.5 (0.25-0.75) | no |
| glycerin | 3 (2-4) | no |
| Octocrylene | 0.3 (max) | no |
| quaternary ammonium salt (BTC 2125) 80% | make up | negligible |
| active | to 0.62-0.64 | |
| | NCL | |
| secondary alcohol ethoxylate (TERGITOL | 1-2 | No |
| TMN-6) 90% active | | |
| sorbitan isostearate (SPAN 120) | 1 (0.75-1.25) | No |
| shea butter | 2 (1.75-2.25) | No |
| ISOPAR V | 20 (18-22) | No |
| Deionized water | Balance | No |

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. An automotive surface treatment system, comprising:
a) an aqueous antimicrobial composition including:
i. an antimicrobial agent which is a combination of quaternary ammonium salts,
ii. a surfactant which is at least one polyoxyalkylene surfactant,
iii. a fragrance,
iv. water, and
v. at least one of a glycol solvent, a conditioner, a shine enhancer, a moisturizer, and a UV protectant,
said antimicrobial composition being formulated for use with automotive surfaces and having a volatile organic content 0.5% by weight or less;
b) a dispense container adapted to retain the antimicrobial composition within the container; and
c) instructions attached to the dispenser, said instructions including directions to apply the antimicrobial composition to an automotive surface.

2. The automotive surface treatment system of claim 1, wherein the quaternary ammonium salt includes n-alkyl dimethyl benzyl ammonium chloride and n-alkyl dimethyl ethylbenzyl ammonium chloride.

3. The automotive surface treatment system of claim 1, wherein the antimicrobial agent further comprises a member selected from the group consisting of e-polylysine, ethylenediaminetetraacetic acid (EDTA), metal cations, essential oils, triclosan, cationic dye, and combinations thereof.

4. The automotive surface treatment system of claim 1, wherein the at least one polyoxyalkylene surfactant includes a polyoxyethylene trimethylnonyl ether surfactant and a secondary alcohol ethoxylate.

5. The automotive surface treatment system of claim 1, wherein the antimicrobial composition is formulated as a cleaning composition having greater than 85% water and includes the glycol solvent.

6. The automotive surface treatment system of claim 5, wherein the glycol solvent includes dipropylene glycol monoethyl ether and diethylene glycol monoethyl ether.

7. The automotive surface treatment system of claim 5, wherein the cleaning composition is formulated as a detailing cleaner and includes the conditioner.

8. The automotive surface treatment system of claim 7, wherein the conditioner includes glycerin and octocrylene.

9. The automotive surface treatment system of claim 1, wherein the antimicrobial composition is formulated as a leather cleaning composition having 65% to 85% water and includes the conditioner, the shine enhancer, the moisturizer, and the UV protectant.

10. The automotive surface treatment system of claim 9, wherein the shine enhancer includes a polysiloxanes, the conditioner includes glycerin, the moisturizer includes aloe, and the UV protectant is 2-cyano-3,3-diphenylacrylic Acid 2-Ethylhexyl Ester (Octocrylene).

11. The automotive surface treatment system of claim 1, wherein the antimicrobial composition is formulated as a protectant composition including the conditioner, the shine enhancer, the moisturizer, and the UV protectant.

12. The automotive surface treatment system of claim 13, wherein the shine enhancer includes a polysiloxane.

13. The automotive surface treatment system of claim 14, wherein the polysiloxane is a polydimethylsiloxane.

14. The automotive surface treatment system of claim 13, wherein the conditioner includes glycerin, the moisturizer includes aloe, and the UV protectant is octocrylene.

15. The automotive surface treatment system of claim 1, wherein the antimicrobial composition is formulated as a spray and the dispense container is a spray bottle.

16. The automotive surface treatment system of claim 1, wherein the antimicrobial composition is disposed on a plurality of wipes and the dispense container is a reclosable container having an access opening from which the plurality of wipes can be removed from the reclosable container.

17. The automotive surface treatment system of claim 1, wherein the instructions are printed directly on the dispense container.

18. The automotive surface treatment system of claim 1, wherein the instructions are printed on a label which is adhered to the dispense container.

19. The automotive surface treatment system of claim 1, wherein the antimicrobial composition is delivered at a neutral pH from about 6 to about 8.5 upon use.

20. The automotive surface treatment system of claim 1, wherein the antimicrobial composition is formulated as an emulsion having an aqueous phase and an oil phase, said oil phase including the conditioner.
